(19) United States
(12) Patent Application Publication
(10) Pub. No.: US 2025/0054188 A1
(43) Pub. Date: Feb. 13, 2025

(54) Method for Determining a Situation of an Object Relative to a Capture Device, Computer Program and Data Carrier

(71) Applicant: Bayerische Motoren Werke Aktiengesellschaft, Muenchen (DE)

(72) Inventor: Dino KNOLL, Muenchen (DE)

(21) Appl. No.: 18/723,525

(22) PCT Filed: Mar. 17, 2023
(86) PCT No.: PCT/EP2023/056913

§ 371 Date: Jun. 24, 2024

(30) Foreign Application Priority Data
Mar. 23, 2022 (DE) 10 2022 106 765.3

(51) Int. Cl. G06T 7/73; G06T 7/50

(52) U.S. Cl. CPC G06T 7/75; G06T 7/50; G06T 2207/10024; G06T 2207/10028; G06T 2207/20081; G06T 2207/20084; G06T 2207/30108; G06T 2207/30204

(57) ABSTRACT

A method for determining a position relative to a capture device of an object having at least one planar surface includes capturing at least one recording of the object includes depth information and image information by a camera; recognizing the object in the image information; retrieving a model of the object includes at least one marker point, the inherent position of which with respect to the at least one planar surface is predefined; plausibilizing the at least one marker point on the object in the recording; calculating a 2-dimensional pose of the at least one planar surface on the basis of the at least one identified marker point in the recording; selecting a point set from the depth information of the recording; and calculating the position of the object by adapting the point set to the calculated pose.

### BACKGROUND AND SUMMARY

The invention relates to a method for determining a situation of an object, having at least one planar surface, relative to a capture device. Further, the invention relates to a computer program. Finally, the invention relates to an electronically readable data carrier.

In logistics, for example during the manufacture of vehicles, load carriers can be used for transporting goods or parts to be manufactured. Load carriers may be in the form of small load carriers, for example in the form of transport boxes. These are transported to and/or kept at production sites, at which they are used for vehicle manufacture, for example, by way of conveying devices, for example.

Automation in manufacture, for example by way of robots, is constantly advancing, and so entire production lines or logistics facilities are now operated in automated fashion. In this case it is advantageous for a situation, that is to say a position and an orientation in space, of objects that are used, such as the load carriers, for example with respect to the robots, to be known as precisely as possible.

As such, US 2021/0004984 A1 discloses a method for training a 6D position estimation network on the basis of iterative deep learning. Further, U.S. Pat. No. 11,182,924 B1 discloses a system for estimating a 3-dimensional pose and for determining one or more biochemical performance parameters of at least one person in a scene.

The problem for the present invention is to provide a method, a computer program and a data carrier that permit an object having at least one planar surface, for example a small load carrier, to be detected particularly advantageously and thus its situation and therefore its position and orientation in relation to a logistics facility, or rotation, to be determined particularly precisely.

This problem is solved according to the claimed invention. Advantageous configurations and developments of the invention are specified in the description and in the drawings.

A first aspect of the invention relates to a method. The method is used for determining a situation of an object, having at least one planar surface, for example a small load carrier having a planar base surface, relative to a logistics facility, which may comprise a transport device and/or a robot, for example. In addition or as an alternative to the base surface, for example a lateral surface of the small load carrier can also be used for the method.

To be able to determine the situation of the object particularly advantageously, the method according to embodiments of the invention comprises multiple steps.

A first step comprises capturing at least one photograph, comprising depth information and image information, of the object by way of a camera. A second step comprises detecting the object in the image information by way of an object detection device. A third step comprises retrieving a, in particular 3-dimensional, model of the object, the model comprising at least one marker point, the individual situation of which in relation to the at least one planar surface is specified and therefore in particular fixed and/or known, on the basis of the detection in the second step. This results in the at least one marker point stored in the model being identified on the object in the photograph, and therefore in a marker point identification. A fourth step comprises carrying out a plausibility check for the previously identified marker points. A fifth step comprises computing a two-dimensional pose, or orientation, of the at least one planar surface of the object on the basis of the at least one identified marker point in the photograph, at least two and in particular at least three marker points advantageously being used for the computation. A sixth step comprises selecting a set of points, which is assigned to the surface of the object, or in which at least one surface is oriented, from the depth information of the photograph. Finally, a seventh step comprises computing the 6-dimensional situation of the object by aligning the set of points, or a surface determined from the set of points, with the computed orientation, the situation describing a position and a rotation, or orientation, of the object relative to the logistics facility.

The first step, capture, can result in the photograph itself being produced by the camera; additionally or alternatively, the data of the photograph can be received from an electronic computing device that performs at least parts of the method. The capture device comprises the camera and, for example, may additionally have a bracket on which the camera is mounted relative to a logistics robot, for example. The bracket may be in static or mobile form, for example.

The camera is in particular in the form of an RGB-D camera and/or in the form of a stereoscopic camera, and so the photographs taken by the camera comprise image information, that is to say for example traditional color information as in the case of conventional photography. Additionally, the photograph comprises depth information produced by way of infrared light reflection and time-of-flight, for example, the depth information in the photograph being able to be included as point clouds of the surroundings in the photograph, for example. To be able to carry out the method, the object should be oriented in relation to the camera such that at least part of the at least one planar surface appears in the photograph.

The camera may be a component of the logistics facility, for example, or is installed at a fixed location at least with respect to applicable components of the logistics facility that receive the objects, for example conveyor belts. This means that an orientation of the camera is known. The object is detected in step 2 of the method according to embodiments of the invention in particular by way of an image recognition or object detection algorithm in the image information and serves to be able to keep the correct model available.

The model of the object may be stored as a 2-dimensional or 3D model, the at least one marker point describing at least one characteristic feature of the object. The model can be trained for the use of small load carriers on the basis of a neural network. Advantageously, the model has at least three marker points and in particular at least four marker points, since the two-dimensional pose can be determined unambiguously. As such, the marker points can describe corners of the at least one planar surface, for example.

This is accomplished using a further algorithm, which can likewise be executed by the object detection device. The algorithms of the object detection device are executed in particular by neural network.

The fourth step comprises plausibilizing the at least one marker point on the object in the photograph. In other words, a plausibility check is performed; this results in logistics-specific post-processing rules being taken as a basis for checking the identified marker points and combining them into marker point combinations.

The fifth step, computation, comprises projecting the surface detected and identified on the basis of the marker points into the image plane of the photograph. This allows for example a distortion due to an oblique situation in relation to the image surface to be detected, which, for example particularly advantageously, allows the two-dimensional pose, or orientation, of the surface to be determined, in particular projected.

The selection of the set of points results in the depth information of the photograph being used, the selection resulting in applicable points that are situated in the planar surface of the object, or can be assigned to said surface at least on the basis of the photograph, being used. The selected points can be used to determine a surface model of a surface that describes the at least one planar surface of the object. Finally, the last step comprises computing the 6-dimensional situation of the object and therefore its position and orientation, or rotation, in space, the selected set of points being aligned with the computed orientation, or pose. This advantageously results in the surface model determined on the basis of the set of points being used, and so the seventh step of the method comprises aligning the surface model with the 2-dimensional pose.

In other words, the method results in an RGB image (that is to say a color image) and an associated depth image being produced as the photograph. In addition, a learning-based approach to object detection is used that, in addition, is also used for 2-dimensional marker point identification (key point extraction). A domain transfer, or domain alignment, then allows in particular marker points that are specific to, or characterize, small load carriers to be detected, for example.

The 2-dimensional pose is computed for example using the coordinates u, v and Φ on the basis of the image information, that is to say in particular in the RGB image, for example by way of projective geometry. The image information is in particular previously identified marker points and/or previously identified marker point combinations. Additionally or alternatively, a 2 dimensional grid is computed on the basis of the image information in the photograph in the domain of the two-dimensional pose of the surface. The sets of points, which correspond in particular to 3D depth points on the basis of the depth information, are selected for example on a random basis within the 2-dimensional grid, which was computed in particular in step 5. Another option and a robust approach to 3D plane determination is for example the plane equation, with for example the so-called RANSAC algorithm being able to be used to carry out a computation. RANSAC stands for “RANdom SAmple Consensus”, meaning agreement with a random sample.

To now compute the situation of the object in the last step, it is possible in particular to project the two-dimensional translation along a normal and a plane, in particular the image plane, an additional possibility being to project the two-dimensional rotation about the normal. By combining the translation and the rotation, a complete 6-dimensional situation, or pose, is therefore now obtained. “6-dimensional” means that three spatial coordinates contain the position, that is to say the distance and direction of the object for example in relation to an origin of a coordinate system and in particular in relation to the capture device, and a further three coordinates contain a skew for example with respect to the three coordinate axes of a Cartesian coordinate system, as a result of which the complete situation, that is to say the position and orientation of the object, can therefore be described.

The invention is based on the insight that conventional approaches, for example two-dimensional computer vision and 3D matching, provide little opportunity for use under factory conditions, for example in vehicle production. As such, light conditions on factory floors may be poor for the camera, for example, which can lead to sensor noise. An underlying assumption is furthermore that definite and known objects need to be “found” in the camera shot and there are substantially identical inputs, in terms of object and photograph, in each pass, this ideal case being inconsistent with practice.

It is advantageous, if the camera can be in the simplest and therefore least expensive form possible, for the method to be particularly robust, which is made possible by a combination of traditional computation and machine learning methods and therefore by way of artificial intelligence, this being achievable in the method according to the invention.

It is thus an advantage of the method according to embodiments of the invention that it can be optimized for example for small load carriers as objects and can therefore be advantageously used in logistics. This leads in particular to especially high precision and/or robustness. In vehicle production, for example, if multiple different objects are used that can be precisely detected, the method is particularly advantageously scalable for various numbers and combinations of small load carriers and can therefore also be used when product and/or container complexity, or object complexity, is high. The method according to embodiments of the invention can thus advantageously result in the problem being broken down into a learning-based approach and a mathematical computation of the pose. Another advantage of the method according to embodiments of the invention is therefore that it scales particularly cheaply, and therefore cheap and/or low-maintenance implementation is achievable. As such, cheap cameras can be used, for example. In addition, for example the nature of the objects, in particular if they are small load carriers, can be taken into consideration, or plays only a minor role. As such, the object may have damage, paint, a sticker and/or the like and still be detected.

In an advantageous configuration of the invention, before computation of the orientation and/or the situation is carried out, a step performed in the method is a plausibility check on the at least one identified marker point, in particular by a post-processing unit. In other words, logistics-specific post-processing rules are defined, in particular. In particular, four marker points are used to determine, or check, the plausibility. Any number of marker point combinations (4 marker points) can be learned here in order to guarantee robustness. However, for industrial practice, this is a trade-off between necessary number of marker point combinations and outlay. In particular two marker point combinations (that is to say 8 marker points) can thus be used.

If the marker points describe the corners of a rectangular, non-square surface of the object, for example, two marker points that are opposite on the short side are at a shorter distance from one another than two marker points that are opposite on the long side of the rectangle. If the plausibility check now determines that the distance between the two identified marker points that ought to be at the shorter distance is longer than the actually longer distance, this results in it not being possible to comply with a consistency defined by the logistics-specific post-processing rules. It may be that two marker points (key points) are determined as being optically above one another that, in reality, cannot be at such a short distance from one another. The further method step of the plausibility check therefore particularly advantageously ensures that errors can be avoided when determining the situation of the object. Such an error could lead to a collision with a robot.

In another advantageous configuration of the invention, the plausibility check results in a geometry and/or a confidence and/or a consistency of the at least one identified marker point being determined. In other words, the logistics-specific post-processing rules determined are a geometry, a distance, a confidence and/or a consistency, and so it is a simple matter to check whether the identified marker points make sense. The confidence can be determined, in particular by way of artificial intelligence, for each marker point separately at first. The plausibility check then comprises comparing each marker point with a minimum value. If, for example for four associated marker points (marker point combinations), at least one marker point is below a threshold value, or the minimum value, the marker point combination is rejected. In industrial practice, a neural network could be well trained so that the rejection of both marker point combinations will be rare. This allows the plausibility check to be performed particularly advantageously.

In another advantageous configuration of the invention, machine learning methods, in particular deep learning and/or at least one convolutional neural network, are used for detecting the object and/or for identifying the at least one marker point. In other words, the primarily machine processing of the photograph is carried out by artificial intelligence, that is to say using automation, such that, for example, an algorithm is used that can detect and handle problems by itself. The convolutional neural network comprises one or more convolutional neural layers followed by a pooling layer. These form a unit that can be repeated as often as desired, in principle. With adequate repetition, the realm of deep learning is attained, which is characterized in that various interlayers of neural networks are arranged between an input and an output layer. Detection of the object is thus advantageously carried out using a first convolutional neural network, and the at least one marker point is identified for example by a second convolutional neural network, which is different than the first neural network and may be in particular a convolutional neural network (CNN) with key feature extraction. The use of machine learning methods results in detection or identification being carried out particularly advantageously and/or efficiently. Suitable training data may be, for example inter alia, marked (labelling) photographs taken previously, the input stored for the training also being able to be, in particular, the respective model of the respective object. This results in supervised learning being used, in particular.

In another advantageous configuration of the invention, the set of points is selected from the depth information on a random basis and/or on the basis of a plane equation. In other words, depth information assigned to the at least one planar surface and consisting of a point cloud, for example, comprising points situated in the surface is selected at random. Additionally or alternatively, the selection is made on the basis of a plane equation. By way of example, this results in the advantage that for example systematic errors in the computation of the situation can be minimized.

In another advantageous configuration of the invention, at least one of the method steps is performed, or at least realized, by way of domain alignment (domain transfer) of a three-dimensional, or six-dimensional, situation determination from a, in particular human, body to the object. Additionally or alternatively, detection of the object and/or identification and/or computation of the orientation, or pose, is carried out on the basis of pattern comparison (template matching).

The domain alignment can result, in particular, in human pose estimation algorithms being used, which typically process image coordinates (2D) and therefore the image information of the photographs. As such, the domain alignment can result in for example known trained machine learning mechanisms that are used to detect the pose of individuals in photographs, for example, being aligned with the object. The pattern comparison, that is to say the template matching, results in small regions of the photograph being matched for example in the image information or a template image that may be included in the model of the object, for example. As a rule, traditional computer vision does not result in a learning-based algorithm being used for the template matching (2D or 3D), but rather a rigid “coincidence”: template matching is a technique in digital image processing to find small portions of an image that coincide with a template image. For the method presented here, a learning-based approach using neural networks/artificial intelligence is preferred. This permits a transfer, that is to say that patterns do not have to be exactly 100% identical. The variance that exists can therefore be reliably reproduced.

The use of domain alignment and/or pattern comparison allows the method to be carried out particularly advantageously, with computing resources advantageously being able to be saved, for example.

In another advantageous configuration of the invention, the two-dimensional pose of the surface is computed by way of projective geometry. Additionally or alternatively, a two-dimensional grid is inserted in the domain of the pose. In other words, perspective representations of three-dimensional items in a two-dimensional plane are depicted in the image information of the photograph. When computing the situation, or pose, the object is therefore situated in a projective plane, or a projective space, as a result of which the pose can be computed particularly efficiently and/or effectively and therefore with high accuracy. The insertion of the two-dimensional grid allows the computation in the seventh step of the method to be performed particularly advantageously, for example, since for example the set of points of the surface can be particularly advantageously aligned with the computed orientation, or pose. This results in the advantage that the method can particularly advantageously determine the situation of the object.

In another advantageous configuration of the invention, when capturing the photograph the orientation of the camera in relation to a logistics facility is specified or known. By way of example, the logistics facility may comprise a robot, with a robot arm, a linear axis, and in particular a mobile transport robot, on which the camera, or the capture device, is mounted. By way of example, the camera may be positioned statically on a ceiling above the logistics facility. Additionally or alternatively, the method is used in vehicle production. This therefore results in the advantage that firstly the situation of the object can be determined particularly precisely and secondly the logistics in vehicle production can be improved.

A second aspect of the invention comprises a computer program. The computer program can be loaded in an electronic computing device of an installation, for example, and comprises program way in order to perform the steps of the method according to the first aspect of the invention when the computer program is executed in the electronic computing device, or for example a control device.

Advantages and advantageous configurations of the first aspect of the invention can be regarded as advantages and advantageous configurations of the second aspect of the invention, and vice versa.

A third aspect of the invention relates to an electronically readable data carrier. The electronically readable data carrier comprises electronically readable control information stored thereon that comprises at least one computer program according to the second aspect of the invention and is configured such that it can carry out a method according to the first aspect of the invention as presented here when the data carrier is used in an electronic computing device.

Advantages and advantageous configurations of the third aspect of the invention can be regarded as advantages and advantageous configurations of both the second aspect and the first aspect of the invention, and vice versa in each case.

Further features of the invention are obtained from the claims, the figures and the description of the figures. The features and combinations of features that are cited in the description hereinabove and the features and combinations of features that are cited in the description of the figures hereinbelow and/or shown in the figures alone can be used not only in the respectively indicated combination but also in other combinations or on their own.

The invention is now explained in more detail on the basis of a preferred exemplary embodiment and with reference to the drawings.

### BRIEF DESCRIPTION OF THE DRAWINGS

FIG. 1 shows a schematic flowchart for a method for determining a situation of an object relative to a logistics facility.

FIG. 2 shows a sequence of method steps of the method shown in FIG. 1 on the basis of photographs from a camera.

### DETAILED DESCRIPTION OF THE DRAWINGS

As a rule, the manufacture of motor vehicles results in small load carriers KLT, which are used to transport components, for example, being used in the relevant logistics area, or for a logistics facility, for example a sorting robot. These small load carriers KLT can be regarded as objects, it being important to know the position and orientation and therefore situation thereof relative to the logistics facility. This allows the robot, for example, to be automated particularly advantageously, for example. The aim below is now to present a method that is intended to solve the problem of permitting robust object detection and location. The intention is to decide what type of small load carrier KLT the object is, since various types of small load carriers KLT can be used in vehicle production, or the logistics facility. The intention is to location, that is to say complete determination of the six-dimensional pose, or situation, and therefore the translation and rotation of the object, particularly advantageously and therefore with particularly high precision.

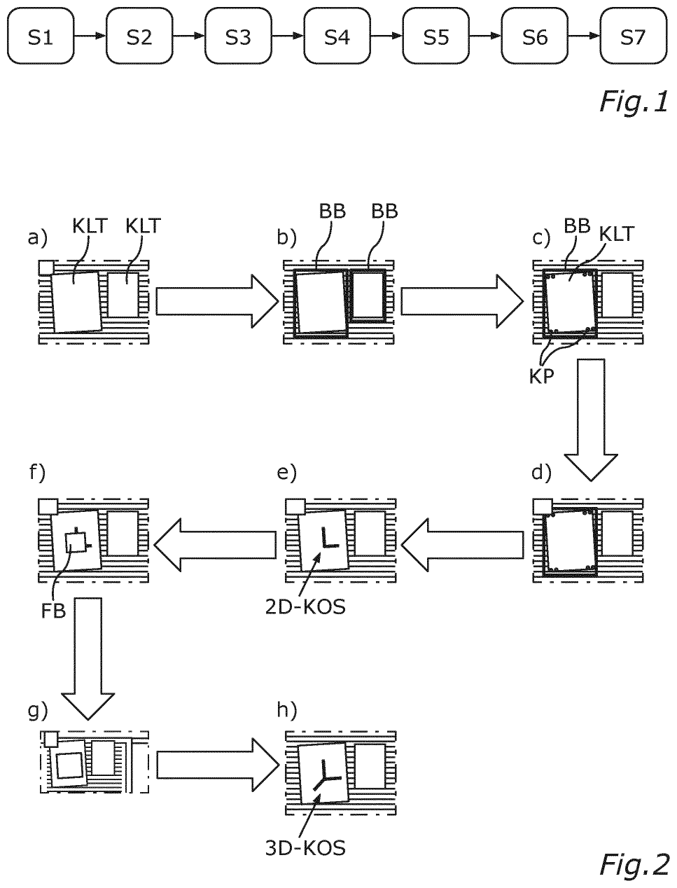

The method now presented is shown in a schematic flowchart in FIG. 1 and comprises the following steps, which lead to a situation of an object having at least one planar surface being determined relative to a logistics facility:

A first step S1 of the method comprises capturing at least one photograph, comprising depth information and image information, of the object by way of a camera, which may be part of the logistics facility, for example.

A second step S2 comprises detecting the object in the image information by way of an object detection device, which can execute in particular an object detection algorithm, which is based on machine learning, for example.

A third step S3 comprises retrieving a, in particular three-dimensional, model of the object on the basis of the object detection, so that the detected object can be assigned the correct model, which comprises at least one marker point KP, the individual situation, that is to say situation, of which in relation to the at least one planar surface is fixed, or known, and therefore specified.

This results in at least one of the marker points KP being identified on the object in the photograph, with an identification device being able to be used. Said identification device may be in a similar form to the object detection device and may execute an algorithm, in particular based on machine learning, that may be an extension of the object detection device.

A fourth step S4 of the method comprises a plausibility check on the identified marker points on the basis of logistics-specific post-processing rules. Furthermore, the marker points KP are combined into marker point combinations.

A fifth step S5 comprises computing a two-dimensional orientation, or pose, of the surface in the photograph and therefore in the image plane on the basis of the at least one identified marker point KP, at least three and in particular four marker points KP advantageously being identified.

A sixth step S6 of the method comprises selecting a set of points from the depth information of the photograph, the set of points having been or being assigned to the at least one plane of the surface of the object, so that a surface model describing the surface can be derived from the set of points.

Finally, a seventh step S7 of the method comprises computing the in particular six-dimensional situation of the object by aligning the set of points, or the surface model derived therefrom, with the computed pose, or orientation, the situation describing a position and an orientation, or rotation, of the object relative to the logistics facility.

An advantage of the method presented is for example that combining a computed approach and machine learning, by way of the neural networks, permits particularly robust detection. This allows problems that arise when small load carriers are used as objects to be dealt with, for example. As such, there may be a particularly high level of complexity, for example, since a large number of different small load carriers KLT can be used in the logistics facility. The sensor used for the photograph, that is to say the camera, may furthermore be just a simple RGB-D camera, thereby allowing low-maintenance operation, which can advantageously also scale well. In addition, advantageous light conditions do not exist everywhere on a logistics facility, for example, which means that sensor noise can occur, this likewise being able to be compensated for particularly advantageously by the method presented. Furthermore, the nature of the small load carriers, for example whether they exhibit different wear phenomena such as stickers, scratches, dirt, oil, broken edges, other damage, incorrect paint, etc., plays a minor role, as this can also be particularly advantageously eliminated on the basis of the combination of the depth information with a neural network pose determination. The advantage of the method presented over traditional computer vision with template matching, where difficulties can be expected with the different wear phenomena, is evident here.

It is advantageous if, before computation of the orientation and/or the situation is carried out, a step performed in the method is a plausibility check on the at least one identified marker point KP, for example by a post-processing device. In particular, the plausibility check results in multiple marker points and marker point combinations being considered. It is advantageous if a geometry and/or a convergence and/or a consistency of the at least one identified marker point KP are determined for the plausibility check.

FIG. 2 uses a photograph from the camera to show how the individual steps of the method are carried out. As such, part a) of FIG. 2 shows the image information of the photograph, in which two different small load carriers KLT are depicted. The respective small load carrier KLT has at least one planar surface, which in FIG. 2 forms the base of the respective small load carrier KLT.

In part b) of FIG. 2, it can be seen that the object detection device has placed a respective bounding box BB around at least one of the small load carriers KLT for step S2 of the method. The left-hand, larger small load carrier KLT in the example is intended to be considered further. The method steps can be performed for every detected small load carrier.

After the object detection on the basis of the bounding box BB, step S3 is performed and the model is retrieved, which comprises the marker points KP. These are then identified by the machine learning method and are marked accordingly, as can be seen in part c) of FIG. 2.

A plausibility check can then be performed, resulting for example in it being detected that identification of the at least one marker point KP, in particular the multiple marker points KP, key points, was successful, as a result of which they have additionally been entered in part d) of FIG. 2. As shown in part e) of FIG. 2, a two-dimensional pose of the surface is then computed, this being depicted by the axes of the coordinate system KOS that are shown.

A point sampling can then be performed, resulting in a set of points that represents the surface of the small load carrier being selected. The selection of the points may be on a random basis and is situated within a grid that was also indicated for the two-dimensional pose, for example. This is depicted in part f) of FIG. 2 by the surface region FB that is shown.

This is then matched against the photograph's depth information shown in part g) of FIG. 2. Finally, as shown in FIG. h) and depicted on the basis of the axis of the third spatial dimension of the coordinate system KOS, the six-dimensional situation of the object, the small load carrier, is computed, this being done by aligning the set of points with the computed pose, the situation describing a position and/or orientation of the object in relation to the logistics facility.

Machine learning methods are advantageously used for steps S2 and S3, with in particular deep learning being used, or at least one convolutional neural network for detecting and in particular another convolutional neural network for identifying; these two networks could also be combined into one network.

Furthermore, at least one of the method steps has resulted in a domain alignment and therefore a domain transfer being performed, for example a neural network that was originally trained to detect the pose of a human being in an image, for example, is aligned. In addition, the object detection and/or the identification of the at least one marker point and/or computation of the orientation of the two-dimensional pose can be carried out on the basis of pattern comparison, template matching. The computation of the two-dimensional pose can result in a projective geometry being used, and a two-dimensional grid is advantageously inserted in the domain of the pose.

The method presented therefore shows an advantageous, robust, hybrid, 2.5D approach for 6D position estimation of small load carriers KLT in logistics by way of deep learning.

### LIST OF REFERENCE SIGNS

S1 first step

S2 second step

S3 third step

S4 fourth step

S5 fifth step

S6 sixth step

S7 seventh step

KLT small load carrier

BB bounding box

FB surface region

KP marker point

KOS coordinate system

1.-10. (canceled)

11. A method for determining a six-dimensional situation of an object having at least one planar surface relative to a capture device, the method comprising the steps of:
capturing at least one photograph, comprising depth information and image information of the object, by way of a camera of the capture device;
detecting the object in the image information by way of an object detection device;
retrieving a model of the object that comprises at least one marker point, the individual situation of which in relation to the at least one planar surface is specified, based on the detection;
plausibilizing the at least one marker point on the object in the photograph;
computing a 2-dimensional pose of the at least one planar surface based on the at least one identified marker point in the photograph;
selecting a set of points, which is assigned to the at least one planar surface of the object, from the depth information of the photograph; and
computing the six-dimensional situation of the object by aligning the set of points with the computed 2-dimensional pose, the situation describing a position and an orientation of the object relative to the capture device.

12. The method according to claim 11, further comprising:
performing a plausibility check on the at least one identified marker point before computing of the orientation and/or the situation.

13. The method according to claim 12, wherein:
the plausibility check results in a geometry, a confidence, and/or a consistency of the at least one identified marker point being determined.

14. The method according to claim 11, wherein:
machine learning methods are used for detecting the object and/or for identifying the at least one marker point.

15. The method according to claim 14, wherein the machine learning methods comprise deep learning and/or at least one convolutional neural network.

16. The method according to claim 11, wherein:
the set of points is selected on a random basis and/or based on a plane equation.

17. The method according to claim 11, wherein:
at least one of the steps is performed by way of domain alignment of a 3D situation determination from a body to the object, and/or detecting the object and/or identifying and/or computing the orientation is carried out based on pattern comparison.

18. The method according to claim 11, wherein:
the 2-dimensional pose is computed by way of projective geometry, and/or a 2-dimensional grid is inserted in a domain of the pose.

19. The method according to claim 11, wherein:
when capturing the photograph, the orientation of the camera in relation to a logistics facility is specified, and/or the method is used in vehicle production.

20. A computer product comprising a non-transitory computer readable medium having stored thereon program code which, when executed on an electronic computing device, carries out the acts of claim 11.
